(19) United States
(12) Patent Application Publication
(10) Pub. No.: US 2009/0153305 A1
(43) Pub. Date: Jun. 18, 2009

(54) Method and System for Locating Objects

(76) Inventor: Antonio Ambrosetti, Varese (IT)

Correspondence Address: COOK ALEX LTD, SUITE 2850, 200 WEST ADAMS STREET, CHICAGO, IL, 60606, US

(21) Appl. No.: 11/994,867

(22) PCT Filed: Jul. 7, 2006
(86) PCT No.: PCT/IB06/52304

§ 371 Date: Aug. 14, 2008

(30) Foreign Application Priority Data
Jul. 8, 2005 (IT) BG2005A000039

(51) Int. Cl. H04Q 5/22

(52) U.S. Cl. 340/10.31

(57) ABSTRACT

A method and a system for locating objects is described, effective against any loss of items. The system is provided with high autonomy, capable of effectively tackling the unforeseeable and variable nature typical of forgetfulness, without for this reason being indiscrete and without the system itself constituting another object to be remembered, or rather not to forget, as well as being able to be integrated in commonly used objects. The system comprises acellular telephone (CELL), equipped with a positioning system (LOC) and with a short range communication interface adapted to allow connection with at least one hardware/software agent (A1- A4) that can be associated with an object that can be lost (O1-O4), which is adapted to cyclically send a presence signal, and to go into a rest mode when there is no reply to the presence signal from the cellular telephone (CELL), and it is adapted to establish a communication with passing mobile terminals, the cellular telephone (CELL) being arranged for running a processing programme to associate the cellular telephone (CELL) with respective hardware/software agents (A1-A4), for checking for the presence of such agents (A1-A4), for searching for their position, storing the time and location of the possible separation and transmitting possible activation commands to them.

The present invention refers to a method and to a system for locating one or more objects, people or animals, in particular of the radio or wireless type.

Remembering where we have left every object (keys, purse, handbag, wallet, remote control, glasses, etc.) that we use every day has become a real challenge for the memory due to the large amount of objects used, in particular for very active people who are very busy. When we search for one of our objects that we cannot find, because we left it somewhere or else because it is hidden by other objects, we lose an infinite amount of time taking us away from other much more important and productive activities. Moreover, when such objects are well and truly lost, substantial damages are often incurred, not just in economic terms, but also emotionally and in terms of time, and this is the case not only for the aforementioned objects (think for example of losing everything that is contained in one's wallet), but also for the possible loss of pets or else for the general need to watch over one's own children.

Systems for finding lost objects by placing a radio receiver comprising a sound emitter that can be activated by a remote transmitter on the various objects are known.

Now, a person must remember where they put the transmitter to be able to look for the object that is lost, and therefore a further object is added to the long list of objects that a person must search for.

It should also be added that if one leaves the field of action of the transmitter there is no longer a way to activate the receivers and therefore one is no longer able to find the objects associated with them.

Systems are also known that automatically indicate that an object, animal or person has left its radius of action by emitting a sound. Such objects do not take account of the fact that in one's daily routine one often moves away for various reasons and that moving away due to carelessness that could cause something to be lost is just an exception to these situations. In these systems this causes excess activation due to false alarms that makes the user only activate these systems in certain situations, whereas the very nature of losing something is unforeseeable, and it could occur at any time. Moreover, the user must also in this case remember to activate such a system.

It should not be forgotten that once the receivers have used up the battery that makes them work, they can no longer emit the sound for them to be found.

Systems are also known which are equipped with battery-free passive sensors (RFID). These systems, however, as well as having limited radius of action and functionality (for example, they cannot have on-board sound alarms), provide for the use of radio systems that, to dialogue with them even over short distances (of the order of a few tens of centimetres), emit large amounts of radio waves thus limiting the lifetime of the batteries of the reader and placing serious doubts over the effect that prolonged close-up exposure to such high levels of radio wave emissions could have on human health. It should also be specified that, currently, there are no commercial mobile terminals that can directly read such sensors (RFID). If one wants to do this, one has to connect the mobile terminal with a suitable reader/writer, but also in this case RFID readers/writers so universal as to be able to be connected to most mobile terminals on the market do not exist.

The purpose of the present invention is to provide a method and a system for locating one or more objects, and by extension also animals or people, which does not have the drawbacks of the prior art.

In accordance with the present invention, such purposes and others are accomplished by a method for locating objects having the characteristics outlined in claim 1.

Such purposes are also accomplished by a system for locating objects having the characteristics outlined in claim 13.

Further characteristics of the invention are described in the dependent claims.

In accordance with the present invention it is possible to make a system having, for example, as transceiver to be applied to the objects that one wishes to keep a watch over, a Hardware and Software Agent (AHS), capable of substantially reducing the consumption of its power source and therefore capable of having a very long useful life.

Preferably, a mobile telephone is used as transceiver to search for the AHS and as management interface of the system. For the purposes of the invention, the mobile telephone is provided with hardware circuits (antenna, microprocessor) for managing short range communications (for example according to a Bluetooth, ZigBee, etc. transmission protocol), possibly integrated on a removable SIM card or on memory cards or other permanent circuit boards inside the apparatus. The required characteristics, i.e. provision of a local wireless interface and the possibility of allowing management programmes of complex applications (for example Java J2ME) to be carried out, are already included in a large number of devices currently on the market.

AHS is able to be located by the mobile telephone in a radius of action of a short range transmission system, for example Bluetooth. In the case in which the AHS and the mobile telephone move apart by a distance greater than such a radius of action, thanks to the storage of the exact time and of the geographical position of the mobile telephone carried out at the moment when the AHS left the radius of action of the telephone (or vice-versa) through the provision of a positioning system associated with the mobile telephone, it is possible to locate the AHS even at remote locations provided that it is not moved by others or it is not associated with animals or human beings that in the meantime will have moved. However, in these last cases, at least a useful “trail” is obtained in terms of place and time of separation, all the more useful the more recently it occurred.

A positioning system via radio managed by a mobile telephone is thus obtained that allows any physical entity (immobile or mobile) to be located anywhere provided that it has previously been associated with an AHS, with the precision of the most modern positioning technologies, without the object to be located being equipped with such systems and thus allowing extremely low costs and energy consumption and much greater operating time, with a single battery.

The system allows people, animals and objects to be located with a mobile telephone by simply associating an AHS with them and providing one's own mobile telephone with appropriate software.

The AHS and the mobile telephone act autonomously in providing and updating the information useful for a possible location request.

In this specific case, the AHS must avoid becoming lost and in any case must be able to be have itself be found, but it must do so without creating situations that can cause the person who owns it to deactivate it (for example, by beeping in public and creating embarrassment).

The AHS can be set to warn with a sound, light or tactile alarm, if it loses contact with its reference mobile telephone, or else it can be left in passive mode.

Passive mode ensures that, in the case in which radio contact is lost between AHS and mobile telephone, the AHS is arranged to exploit any chance to provide updated information on its position for the longest possible time, and that the mobile telephone, in turn, stores the data relative to the last contact (time and coordinates), but that the indication of such information to the user is only carried out upon the request of the user himself and possible updates are only sent while the user maintains a search mode for such an AHS active.

The AHS shall also adopt behaviour aimed at maximising the probability of it being found, like for example saving energy or else behaviour making it easier for it to be found, for example activating the sound alarm indicating its position when the searching mobile telephone is nearby in an active search mode.

AHSs are not equipped with their own positioning systems, but exploit those of apparatuses located nearby, first of all its own reference mobile telephone, otherwise other mobile telephones or transceiver apparatuses with positioning systems that are even for a limited time nearby, i.e. within the radius of action of the predetermined short range communications system.

AHSs also exploit other functionalities of its reference mobile telephone, for example processing capability and graphical interface. Moreover, again through their reference mobile telephone, they exploit the ability to access databases connected to the mobile telephone network. This allows their complexity, and therefore their cost and their energy consumption to be minimized, increasing the time available to be found.

Every mobile telephone, in turn, if requested to do so, can use all of the potential of the network and of other mobile telephones to receive updated information on a lost AHS.

The characteristics and advantages of the present invention shall become clear from the following detailed description of a practical embodiment thereof, illustrated as a non-limiting example in the attached drawings, in which:

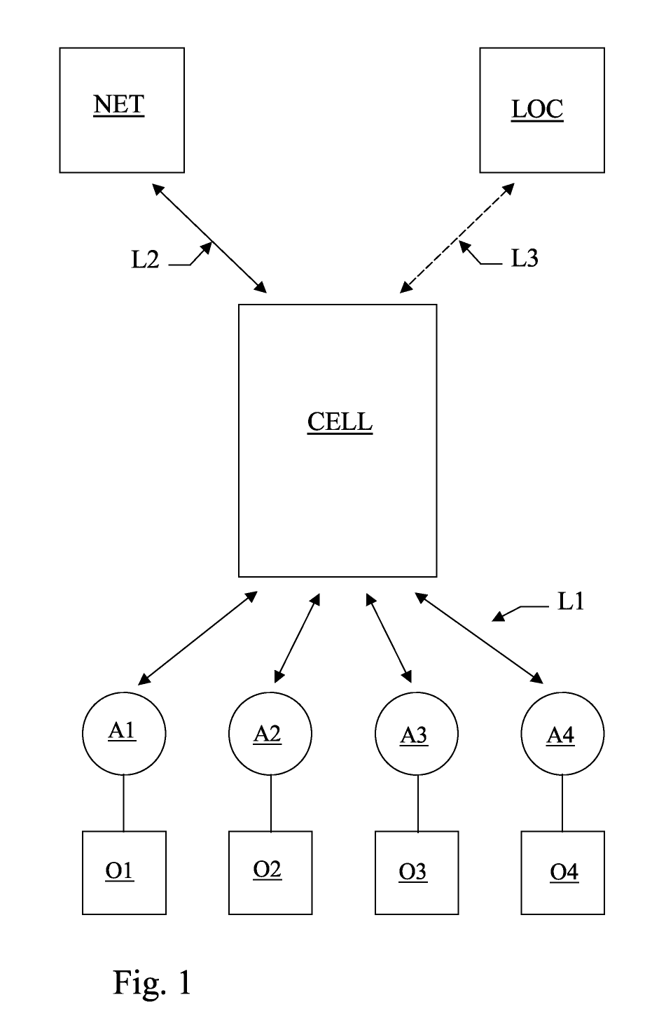

FIG. 1 shows a block diagram of the system for locating objects in accordance with the present invention; and

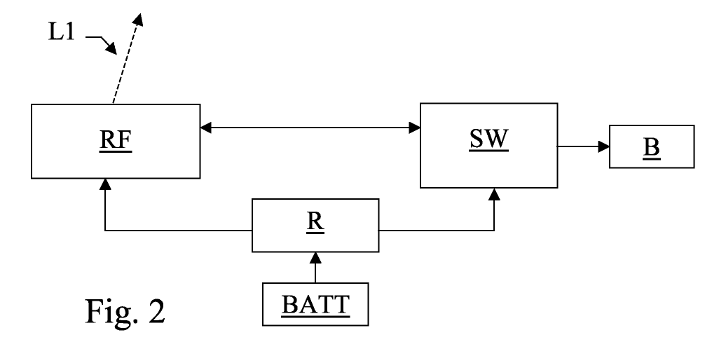

FIG. 2 shows a block diagram of an AHS belonging to the system of FIG. 1.

Referring to the attached figures, an example embodiment of a system for locating objects in accordance with the present invention comprises one or more AHS having reference A1, A2, A3, A4. They are made in a shape and size so as to be able to be associated with, and preferably fixedly joined to, respective objects O1, O2, O3, O4.

Of course, in a broader sense, we do mean that the elements O1-O4 can also be living beings, both animals and people, for which the following considerations continue to be valid.

The transceivers A1-A4 can place themselves in communication, through a short range transmission system L1, for example Bluetooth, with a transceiver CELL, for example integrated in a cellular telephone, electronic notebook, portable computer, black barry, IPAQ or other devices not considered here, without any limitation to the present application.

The transmission system L1 can also be of the ZigBee, HomeRF or UHF radio frequency technology type, or other types not considered here, without any limitation to the present application.

The transceiver CELL can be placed in communication through a communication system L2, for example of the GSM type, with a central control system NET, for example a cellular telephone network like GSM.

The communication system L2 can also be of the GPRS, UMTS, Wi-Fi or VOIP type, or other types not considered here, without any limitation to the present application.

The transceiver CELL can also be placed in communication, through a transmission system L3, with a system LOC for determining its own geographical position, for example GPS.

The positioning system LOC can also be of the AGPS, TOA, E-OTD or WOZ type, or other types not considered here, without any limitation to the present application.

The transmission system L3 is used to determine the geographical position of the transceiver CELL. Such a system is not necessary when the transceiver CELL can determine its geographical position in a sufficiently precise way through other means, like for example the cellular telephone network of the GSM or UMTS type, and thus using the transmission system L2.

The transceivers A1-A4 comprise a power source BATT that, through a voltage regulator R, feeds other circuits of the transceiver A1-A4. They also comprise a radio frequency circuit RF for connection with the transceiver CELL, a control circuit SW of the entire transceiver A1-A4 and a sound alarm B.

The control circuit SW, which can include a microprocessor also with built-in management software, allows the following functions to be carried out, considering, just as a non-limiting example, the case of connection L1 through Bluetooth technology, and in the case of a transceiver CELL of the UMTS type with Bluetooth technology.

At the time of the first connection, the transceiver A1-A4 establishes a pairing with the transceiver CELL (reference transceiver).

At every subsequent connection the transceiver A1-A4 connects to the reference transceiver CELL trying to establish a communication session with it. Then, the. transceiver A1-A4 behaves as Bluetooth MASTER, whereas the transceiver CELL behaves as SLAVE.

After having established connection with the reference transceiver CELL, the transceiver A1-A4 sends its identity code, then waits for a possible command for a predetermined waiting time, for example about 2 seconds.

If during this waiting time the transceiver A1-A4 does not receive a command from the transceiver CELL, then it switches into rest mode for a predetermined rest time period, for example about 10 seconds. During this rest time the transceiver A1-A4 absorbs practically no current from its power source. Then, the transceiver A1-A4 shall make contact again with the reference transceiver CELL, and shall make this query cyclically.

If during the waiting time the transceiver A1-A4 receives a predetermined command from the queried transceiver CELL, then the transceiver A1-A4 switches to terminal mode and is ready to receive specific commands.

The specific commands are for example commands to activate the sound alarm B, possibly with different possibilities of tones, to check the status of the battery, to check the version of software present on board, and to leave terminal mode state to return to behaving as MASTER.

A software for the management of the system and for user interface is loaded onto the transceiver CELL, having processing means adapted for running processing programmes, for example Java J2ME, through typical loading modes of applications in J2ME on cellular phones equipped to handle such software language, which are well known. The software uses the display of the transceiver CELL as graphical user interface (GUI) to carry out the operations of the system. The objects with which the AHSs are associated are preferably represented by icons on the display of the transceiver CELL. At the initiation step there is the possibility of associating an identity code and an icon for each AHS used. It is possible to set it up so that if the object is within the radius of action of the transmission system L1 (for example, Bluetooth) the icon shall be bright, if the object is outside of such a radius of action the icon shall be faded (duller than the background).

The software is set up so that when an AHS leaves or is about to leave the radius of action of the transmission system L1, for example when the signal received is less than a predetermined threshold due to the AHS and the reference transceiver CELL moving apart from one another, the exact time shall be recorded, it shall also be requested to determine the geographical position of the transceiver CELL, either directly through the GSM/UMTS system and the transmission system L2, or else through the use of local resources to the transceiver CELL, like for example a GPS or AGPS receiver. The time and the position are stored in the transceiver CELL so as to be able to be brought up at a search step.

In the case in which the AHS falls within the radius of action of the transmission system L1, the icon shall return to normal (from faded). In the case in which it leaves again, the time and position data shall be updated. This process shall be repeated each time the object leaves the radius of action of the transmission system L1.

The software of the transceiver CELL is set up so that in a search step, upon the request to locate an object, for example by selecting the icon or by pressing the button assigned to it, if it is located within the radius of action of the transmission system L1 (normal icon), it will emit a sound, in the negative case (faded icon) the last geographical position stored in the transceiver CELL and the time associated with it shall be requested. To make it easier to find the object, the transceiver CELL shall make a request to the central control system NET to provide it with a map of the area of the stored geographical position. This is one of the aspects that allows traffic to be generated for a telephone operator.

Moreover, in the case in which the user has enabled a function defined as “community”, the transceiver CELL shall take care of sending the identity code of the AHS via L2 to the central control system NET. Such a code shall be inserted from the control system NET into a suitable database of lost AHSs.

In the case in which any transceiver CELL, set up in accordance with the present invention and provided it is enabled for the purpose (community function) receives a cyclical query from an AHS of an object that is not its own, since it is in the radius of action of its transmission system L1, it sends the identity code of the AHS received to the central control system NET. In the case in which this corresponds to a code of an AHS inserted in the way described above into the database of lost AHSs, the system NET shall ask the queried transceiver CELL, via L2, to send its coordinates and the time of the sighting. Such information is sent by the system NET, again via L2, processed in the form of a map and time, to the transceiver CELL that had previously inserted such an AHS into the database of lost AHSs. This operation shall be repeated by any transceiver CELL set up in accordance with the present invention, until the transceiver CELL that had inserted the AHS into the database of lost AHSs sends the instruction to cancel the AHS from such a database. This circumstance can occur either carried out manually by the user (through GUI) or automatically by the transceiver CELL at the time when the lost AHS goes back into the radius of action of LI. Moreover, at the time when the AUS being searched goes back into the radius of action of the transmission system L1 of its own reference transceiver CELL, it shall preferably automatically command the AHS to activate its sound device. The transceiver CELL itself in this situation shall activate on itself or another alarm either a vibration or another indicator aimed at alerting the user even in situations in which they might not hear the sound alarm of the AHS. The community system is preferably built with security criteria such that it is not possible to use it to look for other peoples lost AHS on purpose. The user who owns the mobile apparatus that acts as gateway preferably is not aware that a lost AHS is using it to indicate its position.

The community function constitutes another aspect that generates traffic for a telephone operator. This function also has particular importance since as well as constituting an extremely effective way to find one's objects, it extends the application of this system to the locating of people and animals that can move with respect to the last localization carried out by its own transceiver, and also makes it suitable for being used as an anti-theft device for objects of any type, including the most common means of transport like bicycles, motorcycles, cars, etc.

The system for locating objects in accordance with the present invention is thus able to carry out the following operations using just a graphical user interface (GUI), which is for example carried out as a Java J2ME programme on a normal cellular telephone:

1) Looking for objects in the nearby area. By clicking on an object whose icon is not faded the sound alarm B inside the transceiver A1-A4 is activated. In this way it is possible to look for a transceiver A1-A4 that is nearby, or rather within the radius of action of the transmission system L1. One of the activations commands of the sound signal B is sent to the predetermined transceiver A1-A4.

2) Requesting the position or the map of a lost object. By clicking on an object whose icon is faded the transceiver CELL is asked to show the geographical position of the predetermined transceiver A1-A4 at the time when contact was lost through the transmission system L1 with the transceiver CELL, and the recording of the hour. A request for the map relative to the position stored by the transceiver CELL is forwarded to a remote server, arranged at the central control system NET, or the relevant portion of map is recalled from the memory of the cellular telephone. At the same time, it is checked whether the predetermined transceiver A1-A4 falls within the radius of action (maximum distance allowed between CELL and AHS). If the predetermined transceiver A1-A4 falls within the radius of action the command to activate the sound alarm B is sent to it.

3) Community function. If the “community” function is activated, by clicking on an object whose icon is faded, two maps or two positions can be received in reply: one indicating where the predetermined transmitter A1-A4 was lost, the other indicating the last point where the predetermined transceiver A1-A4 was seen by any transceiver CELL enabled with community function according to the present invention.

4) Preventing an object from getting lost. The transceiver CELL starts sounding when the transceiver A1-A4 leaves the radius of action of the transmission system L1, for example in the case of the Bluetooth system, when it leaves an area of about 10 metres.

It should be repeated that the purpose of an AHS is to try not to be lost by its own reference transceiver CELL without for this reason being too indiscrete and continuing to sound. Therefore, the prevention function is optional and deactivatable without for this reason making the system ineffective.

Every AHS tries to remain operational for the longest possible time through two combined strategies. The AHS stays in rest mode (very low energy absorption) for a predetermined rest time. It only wakes up for the time strictly necessary to check whether a connection L1 of its reference transceiver CELL or of another transceiver CELL enabled for the purpose is active nearby. It can be provided that the AHS progressively changes (increases) the rest time as the charge status of its internal power source decreases.

The AHS can be provided with normal replaceable or rechargeable batteries, or else with solar cells, or other systems for recharging the internal power source, for example the charging system through surrounding vibration energy-collection devices. Once the autonomous internal power source does not have enough charge to allow at least a radio connection, the AHS continues to remain in its rest state. If such a source is sufficiently charged, the AHS carries out its cyclical query and tries to make a connection with any transceiver CELL within its radius of action. The software, installed on the mobile apparatuses CELL, is always in the background to listen whether any AHS is making its cyclical query requesting connection.

We define the behaviour of the AHS parasitic since it manages to provide its location data without possessing its own positioning resources.

Summarizing, we propose a wireless positioning system of people/animals/objects for forgetful people, equipped with high autonomy, low electrosmog levels and capable of generating traffic for a telephone operator. By the term “for forgetful people”, we mean a system capable of effectively tackling the unforeseeable and variable nature typical of forgetfulness, without for this reason being indiscrete and without the system itself constituting another object to be remembered, or rather not to forget. Such a system comprises in its currently preferred embodiment, a cellular telephone (CELL), for example GSM, UMTS, etc., equipped with a positioning system (UMTS, GPS, AGPS, TOA, E-OTD, etc.) and with a communication interface (Bluetooth, ZigBee, etc.) that allows it to connect with at least one hardware/software agent (AHS) with the function of not getting lost/getting itself found, which cyclically sends an existence signal, tries to remain active for as long as possible and is capable to exploit the possibilities of communication offered by terminals occasionally passing by; the cellular telephone being set up to run a software, for example in J2ME, Symbian, etc., capable of associating the cellular telephone CELL with its AHS, checking the actual presence of such agents and looking for them if requested, storing the time and location of their possible loss, displaying the charge status of their batteries, transmitting possible commands to the AHSs, allowing AHSs that are not its own to exploit the cellular telephone itself as carrier gateway to get itself found.

The system thus conceived can undergo numerous modifications and variations, all of which are covered by the inventive concept as defined by the attached claims; moreover, all of the details can be replaced with technically equivalent elements.

1. Method for locating objects, comprising the steps of:
associating a respective first transceiver (A1-A4) with each of said objects (O1-O4); and
providing at least one second transceiver (CELL) adapted to dialogue with said first transceivers (A1-A4);
characterised in that it comprises the steps of:
making a cyclical query from a first transceiver (A1-A4) to the second transceiver (CELL);
sending an identity signal of said first transceiver (A1-A4) to the second transceiver (CELL); and
waiting for a reply from the second transceiver (CELL) for a predetermined waiting time,
and in that, in the absence of a reply, said first transceiver (A1-A4) goes into a low power consumption mode for a predetermined period of rest time before carrying out a subsequent cyclical query.

2. Method for locating objects according to claim 1, characterised in that said first transceiver (A1-A4) is adapted to establish a communication with said second transceiver (CELL) through a communication system (L1) having a predetermined radius of action.

3. Method for locating objects according to claim 2, characterised in that it also comprises the steps of:
determining the position of said second transceiver (CELL) when it leaves said radius of action; and
storing said position in a memory in said second transceiver (CELL).

4. Method for locating objects according to claim 2 or 3, characterised in that it also comprises the steps of:
determining the date and time of when said second transceiver (CELL) leaves said radius of action; and
storing said date and time in a memory in said second transceiver (CELL).

5. Method for locating objects according to claim 1, characterised in that when there is a reply from said second transceiver (CELL), the first transceiver (A1-A4) goes into a standby mode.

6. Method for locating objects according to claim 2, characterised in that it comprises the request, from said second transceiver (CELL), to an identified first transceiver (A1-A4), to emit a sound if said first and second transceiver (A1-A4; CELL) are within said radius of action.

7. Method for locating objects according to claim 2, characterised in that it comprises the step of emitting a sound from said second transceiver (CELL) if said first transceiver (A1-A4) leaves said radius of action.

8. Method for locating objects according to claim 3, characterised in that it comprises the step of displaying the stored position of said second transceiver (CELL) if said first and second transceiver (A1-A4; CELL) are not located within said radius of action, as information representative of the position of said first transceiver (A1-A4).

9. Method for locating objects according to claim 3, characterised in that it comprises the step of requesting, from said second transceiver (CELL), to a central control system (NET), for a map of the area surrounding said stored position if said first and second transceiver (A1-A4; CELL) are not located within said radius of action.

10. Method for locating objects according to claim 2, characterised in that it comprises the step of sending, from said second transceiver (CELL), to a central control system (NET), a search request of said first transceiver (A1-A4) if said first and second transceiver (A1-A4; CELL) are not located within said radius of action.

11. Method for locating objects according to claim 2, characterised in that it comprises the steps of:
providing a third transceiver (CELL); and
sending position information of said third transceiver representative of the position of said first transceiver (A1-A4) to a central control system (NET) if said first and third transceiver are located within said radius of action.

12. Method for locating objects according to claim 11, characterised in that it comprises the step of requesting, from said second transceiver (CELL), to said central control system (NET), a plurality of maps of the areas surrounding the positions of said second and third transceiver if said first and second transceiver are not located within said radius of action.

13. System for locating objects comprising a respective first transceiver (A1-A4) associated with each of said objects (O1-O4), and at least one second transceiver (CELL) adapted to dialogue with said first transceivers (A1-A4);
characterised in that each first transceiver (A1-A4) comprises means for making a cyclical, query to said second transceiver (CELL), means for sending an identity signal of said first transceiver (A1-A4) to said second transceiver (CELL), and is arranged to wait for a reply from said second transceiver (CELL) for a predetermined waiting time and, if there is no reply, to go into a low power consumption mode for a predetermined rest time before making a subsequent cyclical query.

14. System for locating objects according to claim 13, characterised in that said first transceiver (A1-A4) is adapted to establish a communication with said second transceiver (CELL) through a communication system (L1) having a predetermined radius of action.

15. System for locating objects according to claim 13, characterised in that said second transceiver (CELL) is a mobile telephone.

16. System for locating objects according to claim 14, characterised in that it comprises storage means adapted to store information relative to a search request of said first transceiver (A1-A4) if said first and second transceiver (A1-A4; CELL) are not located within said radius of action.

17. System for locating objects according to claim 16, characterised in that it comprises at least one third transceiver and storage means adapted to store position information of said third transceiver representative of the position of said first transceiver (A1-A4) if said first and third transceiver are within said radius of action.

18. System for locating objects according to claim 13, characterised in that it comprises a mobile telephone (CELL) provided with an associated positioning system (LOC) and with a short range communication interface adapted to allow its connection (L1) with at least one hardware/software agent (A1-A4) able to be associated with an object that can be lost (O1-O4), which is adapted to cyclically send a presence signal, to go into a rest mode for a predetermined rest time when there is no reply to the presence signal from the mobile telephone (CELL), and is adapted to establish a communication with third mobile terminals present within its radius of action of communication;
said telephone apparatus (CELL) comprising processing means including a processor programme arranged for associating said telephone apparatus (CELL) with respective hardware/software agents (A1-A4), for checking for the presence of such agents (A1-A4) and transmitting commands to them, searching for them upon request and storing the time and location of their possible separation.
